(19) United States
(12) Patent Application Publication
(10) Pub. No.: US 2019/0150382 A1
(43) Pub. Date: May 23, 2019

(54) Farming Sargasso

(71) Applicant: Pablo Emilio Luzuriaga, Plantation, FL (US)

(72) Inventor: Pablo Emilio Luzuriaga, Plantation, FL (US)

(21) Appl. No.: 16/173,844

(22) Filed: Oct. 29, 2018

Related U.S. Application Data
(60) Provisional application No. 62/578,503, filed on Oct. 29, 2017.

(51) Int. Cl. A01G 33/00; A01D 44/00; E02B 3/04

(52) U.S. Cl. CPC A01G 33/00; E02B 3/04; A01D 44/00

(57) ABSTRACT

Pelagic Sargasso nowadays is an inopportune event that invades beaches. This method has many aspects in consideration to successfully grow Sargasso in huge amounts in a designated area. It also discloses many Sargasso Nursery Structures that adapt to different areas and purposes. This method also discloses where and how to set the nurseries in a way that the Sargasso mass can be used or delivered avoiding heavy costs of shipping.

### CROSS-REFERENCE TO RELATED APPLICATIONS

This applications claims the benefits of provisional patent application Ser. No. 62/578,503. Filled 2017 Oct. 29 by the present inventor.

### BACKGROUND—PRIOR ART

The following is a tabulation of some prior art that presently appears relevant:

U.S. Patents

| Pat. No. | Issue Date | Patentee |
|---|---|---|
| CN 102771377A | 2012 Aug. 16 | Xie Enyi |
| U.S. Pat. No. 6,312,709B1 | 2000 May 18 | Vivien Gore Allen |
| U.S. Pat. No. 4,769,223A | 1993 Apr. 13 | Bohumil Volesky |
| U.S. Pat. No. 5,229,118A | 1991 Sep. 30 | William E. Campbell |
| U.S. Pat. No. 3,415,928A | 1964 Jul. 24 | Nadal Noemi Martinez |

### NONPATENT LITERATURE DOCUMENTS—WEBPAGES

www.hboi.fau.edu FAU OSLS Secrets of the Sargasso Sea

### BACKGROUND

Explaining the purpose of this method of growing Sargasso, it will be easy to understand its background. This method addresses three issues:

1 The raising of the sea levels. Slowly but steadily the Atlantic beaches, the houses and communities are being assailed by the sea. The rising of the sea frustrates home owners as they feel powerless as storms and waves are hitting stronger season after season.

2 The nutrients of the soil are washed away to the ocean. As the World human population grows it requires more food to feed them. The extensive agricultural practices in the past and present requires tillage of the soil and the washing of organic material and nutrients from the soils and the use of more fertilizers. As the cycle repeats, the soils are losing structure and productivity and all minerals are washed away ending up at the sea. The accumulation of nutrients in the seas also have an impact in the sea ecosystem. The result of the mineral excess promotes the overgrowth of algae which may produce red tides toxic for fishes and affects the fishing industry.

3 In South Florida there is not affordable farming land. As South Florida human settlements continue to grow, reducing even more land for farming and the growing the demand for food. Prices of land soar. The quality of the soil is poor and sandy. Sea levels are rising and this infiltrates the underground waters. It is becoming harder to produce vegetables for the local markets.

Sargasso has the potential to counteract these three contemporary problems mentioned above.

I will clarify the differences between pelagic Sargasso and other seaweed, in order to explain later the differences between nurseries to grow benthic seaweed and pelagic Sargasso.

Most seaweed live in the sea bed attached to rocks or other object. They are called benthic seaweeds. They capture the diffused sunlight that reaches the bottom of the ocean, and take the nutrients from the water as they grow in these conditions. Seaweeds with wide leaves thrive at the seabed where waves don't hit with all their strength. In South East Asian cultures they are farmed and also used to reduce pollutants in the sea waters.

There are many patents for growing benthic seaweed in trays and frames. The benthic seaweed always grows attached to a part of the nursery bed. They have a rigid frame, also they have a mooring system and floats. Henceforth they are able to grow the seaweed in a specific location and depth of the sea. They are located where they receive light filtered by the above water and deep enough to be protected from strong waves. The floats need to be attached to the frame and it has to be solid so all the structure is lifted.

My structures are designed to grow pelagic seaweed like Sargasso. Sargasso seaweeds have completely different requirements and properties, consequently the structures are completely different. Pelagic seaweed live unattached to any structure. They float so they receive abundant sunlight.

There is no patented structure designed to grow pelagic seaweed. The structures to grow benthic seaweed are not suitable to grow pelagic seaweed, as the ones to grow pelagic seaweed are not suitable to grow benthic seaweed. They are different structures to grow different seaweeds.

Furthermore, doing a cost comparison between structure prices vs. nursery area, my structures are much cheaper.

Briand E Lapointe subsidized by the Gas Research Institute discloses in the early eighties the idea of doing huge farming in the North Atlantic and Sargasso Sea, harvesting pelagic Sargasso as a source of bio fuel. (See online at FAU OSLS—Secrets of the Sargasso Sea). However he did not reveal any structures specifications. Moreover he proposed to do it in the Sargasso Sea, a place where the water is not warm and has no nutrients. This area is called the dessert sea. Sargasso seaweed drifts and survives or dies there. That is not the place to set a Sargasso farm. I understand that Lapointe's idea was just to harvest it from there. He did not disclose any specification about the farming structures, only the idea to do it in a place where there is not chance for it to prosper, and with different purpose from mine.

The problems that my method solve are completely different, for instance, the rising sea was not an issue at that time.

### ADVANTAGES

Several advantages of one or more aspects of my method are as follows:
Protects shores prone to flooding by adding rich soil and rising the shore level. Sea barriers also can be created with the same purpose.
Helps to capture the enormous amount of nutrients that are washed away to the oceans and bring them back to the soils.
Creates new fertile land around big cities close to the ocean to produce vegetables and fruits.
Sargasso seaweed is an excellent fertilizer for trees during their fruit bearing season.
Sargasso seaweed is excellent as chicken beds in poultry farming.
The nursery's structure simplicity and cost effectiveness, allows it to create giants nurseries and produce tons of seaweed monthly.
Sargasso seaweed can be used for human and animal consumption.
Sargasso seaweed prevents the formation of red tide absorbing all nutrients from the sea.
Sargasso seaweed can be used to stabilize islands, rise soil level, expand or build artificial islands.
In agriculture and hydroponics Sargasso seaweed can be used mixed with sand.
The structures keep beaches clean by retaining the Sargasso before it reaches the shore.
Sargasso seaweed take carbon dioxide and control global warming.
Sargasso seaweed can be used in fish nurseries controlling pollutants derived from fish waste.
Sargasso seaweed can be used in fish nurseries as food and as a spawning place
Sargasso seaweed can be used as another natural fish habitat.
Sargasso seaweed can be used to obtain omega 3 fatty acids as a healthy diet supplement.
Sargasso seaweed can be used as heavy metal absorbers.
Sargasso seaweed can be used for turtle nurseries.
Sargasso seaweed can be used as mulch.
Sargasso seaweed can be used to contain and absorb oil spills.

### DRAWINGS—FIGURES

The embodiments do not have specific size, as they always adapt to the area that has different shapes, depths, currents, waves, winds. Parts of the structure are above and other below the sea level. Waves and currents shape the net. The seaweed content also influence its shape. When an internal net has Sargasso at both sides it is impossible to draw it and represent the nursery structure. For clarification purposes, sometimes I will represent that embodiments with diagrams showing the net completely expanded.

FIG. 1 shows a lateral view of the “surrounding bag” (First Embodiment) wherein the seaweed mass is completely surrounded by the net.

FIG. 2 shows a cross sectional view of a diagram of “the surrounding island structure” (Second Embodiment).

FIG. 3 shows a cross sectional view of a diagram of an ocean outfall surrounded by the filtering dome shelf (Third Embodiment).

FIG. 6A shows a plan view of a “big cage” (Sixth Embodiment).

FIG. 6B shows a lateral view of a “big cage” of an external mesh wall attached to the fifty five plastic drum. (Sixth Embodiment)

FIG. 6C shows a lateral view of a “big cage” Sixth Embodiment of an external mesh wall attached to the rod covered with a pool noodle. (Sixth Embodiment optional construction).

FIG. 7 shows a plan view of a “barrier protective stripe” (Seventh Embodiment).

FIG. 8A shows a plan view of a sand bar formation stripe (Eighth Embodiment).

FIG. 8B shows a cross sectional view of an internal border net with a pouch shape (Eighth Embodiment).

FIG. 9A shows a plan view of a kite shape structure (Ninth Embodiment).

FIG. 9B shows a cross sectional view of a kite shape structure (Ninth Embodiment).

FIG. 10 shows a plan view of an islet with an attached kite structure (Thirteen Embodiment).

FIG. 11 shows a plan view of a Sargasso liquefying plant.

FIG. 12 shows a map of the Pensacola-Clearwater nursery model.

Drawing Reference Numerals

| | |
|---|---|
| 1 | Sargasso Seaweed Mass Alive |
| 2 | Seabed |
| 3 | Sea Level |
| 4 | Seaweeds and Dead Seaweed |
| 5 | Mooring Helical Screws |
| 6 | Mesh |
| 7 | Upper Side |
| 8 | Mangrove |
| 9 | Surrounding Bag End Opening |
| 10 | Floater |
| 11 | Shore |
| 12 | Lineal Anchor Ribbon |
| 13 | Lights |
| 14 | Cleats |
| 15 | Carabiner Hooks |
| 16 | Adjustable Rope |
| 17 | Ocean Outfall |
| 18 | Grid at the Seabed |
| 19 | “V” Shape Mesh |
| 20 | Weight |
| 21 | Funnel |
| 22 | Solar Panel |
| 23 | Pouch Shape Net Entrance |
| 24 | Shore Barrier Embankment |
| 25 | Buffer Zone |
| 26 | Pouch Net Bottom |
| 27 | Kite Structure Point |
| 28 | Expandable opening |
| 29 | Tubular shape net |
| 30 | Main directions of the waves |
| 31 | External Mesh |
| 32 | Islet |
| 33 | Sand |
| 34 | Plastic rope |
| 35 | Mooring object |
| 36 | Internal mesh |
| 37 | Lid of the plastic drum |
| 38 | Fifty five gallon plastic drum |
| 39 | Continuous tubular floater |
| 40 | Fiberglass Rod |
| 41 | Pouch Mesh Entrance |
| 42 | Pool Noodle |
| 43 | River |
| 44 | Fresh Water Pond |
| 45 | Wide Pipe |
| 46 | Pipeline |
| 47 | Sargasso Nursery Structure |
| 48 | Retractable Mesh |
| 49 | Pump |
| 50 | Pretreated Wood Pole |
| 51 | Lower Side |

### INTRODUCTION TO SARGASSO

Sargassum is a vast genus of seaweed composed of many different species. They grow mostly in temperate and warm waters. Two well known, edible benthic seaweeds (Hijiki and Limu Kala), not related to my structures are farmed and harvested for consumption in China.

The two pelagic seaweeds (Sargassum natans and Sargassum fluitans) which will be used in my structures, thrive in the Caribbean and Antilles Sea. These seaweeds developed floating bladders and they grow without any attachment. They live adrift carried by the Gulf Stream Currents and return to the Caribbean carried by the Atlantic Meridional overturning circulation. They thrive in neritic waters filled with nutrients and plenty of sunlight. In perfect conditions they double their mass every twenty one days. The pelagic adaptation gives these seaweeds a clear advantage over benthic seaweed. Benthic seaweed only grows in a narrow strips close to the shore, in a very limited depth range. At a deeper sea level, the light would be too diffused. At shallower levels, the strong waves would destroy them. On the other hand pelagic seaweeds float adrift and receive full sunlight. However, when they are exposed to the full sunlight, they adapt to the excess of light by reducing the speed of their metabolism. Sargasso seaweed can live in thick masses receiving the filtered light from the seaweeds above. Pelagic seaweed have thin strong leaves and they are adapted to withstand the strength of the waves. Another advantage is that they propagate by fragmentation. Benthic seaweeds are destroyed when exposed to waves. Pelagic seaweed moves freely with the waves and fragments and creates new seaweed. This adaptation, however, has a big disadvantage. Sargasso cannot control not even a bit where they go. They are thriving in perfect water and next wave they are out of the sea under the scorching sun. So the cycle of life of the seaweed is always unpredictable. The specie had adapted to this fate by growing and fragmenting faster than any other seaweed, and it had succeed.

During 1980 local people used Sargasso as fertilizer in North Carolina. Ships harvested from the sea and used locally as fertilizers in the field.

Recognizing its significance as an eco-habitat in the 1990's the National Oceanic and Atmospheric Administration (NOOA) designated the pelagic seaweed as an Essential Fish Habitat which resulted in a phase-out of commercial harvesting in U.S waters. In 1998 GOBI Global Ocean Biodiversity Initiative declared this habitat of pelagic seaweed as EBSA Environmental Biological Significant Area. In 2002 the South Atlantic Fishery Management Council established the Second Revised Final Fishery Management Plan for Pelagic Sargasso Habitat of the South Atlantic Region. Henceforth Sargasso harvesting had ended. Even though before 2002, the harvesting of it was not commercially viable. The appearance and disappearance of Sargasso is unpredictable, in the sea they travel in narrow lines separated by the next line by hundreds of meters. Therefore the sea area covered by Sargasso is minimal, but they are an oasis of life for hundreds of creatures.

Depending on the currents, sometimes the Sargasso accumulates on beaches and shorelines. Sargasso lines are washed away off the beach in hours. Sometimes they are pounded by breaking waves and the Sargasso loses its air bladders and sink resulting in Sargasso covered beaches and shorelines, and also creating black clouds covering the seabed. Beach goers find this undesirable, hindering their enjoyment of the beach. People, when going to the beach, expect to find clean sands and blue waters, and to be able to see their feet under the water, and nothing else. In this manner Sargasso poses a problem for beaches. However from the ecological standpoint those clean beaches and transparent waters are an ecological desert. Sargasso is crucial because where there is Sargasso, there is life. Many species, turtles, birds, fishes, crabs, crustaceous, shells depend on Sargasso. So when Sargasso travels adrift, it carries all life with it.

### EMBODIMENTS

Areas in the sea are topographically different in its wave strength, currents, location of the shore etc. Depending on these characteristics the structure is chosen. Sometimes different embodiments work together having different functions as part of an assembly. Sometimes they are used alone. The mesh to be used in the embodiments can be of any color and material and sometimes, depending on the sea, the sieve opening can be bigger or smaller but the ideal mesh would have an aperture of one inch, and be plastic. The best color is green because it reacts to ultraviolet light. Birds, turtles and fishes perceive color green when it reacts to ultraviolet light thereby they are able to avoid getting trapped in it. A small solar panel fabric and green LEDS attached to the net have been proven to reduce the death of turtles and birds. It will also avoid being hit by a boat. That is the type of mesh I will be using in the next embodiments.

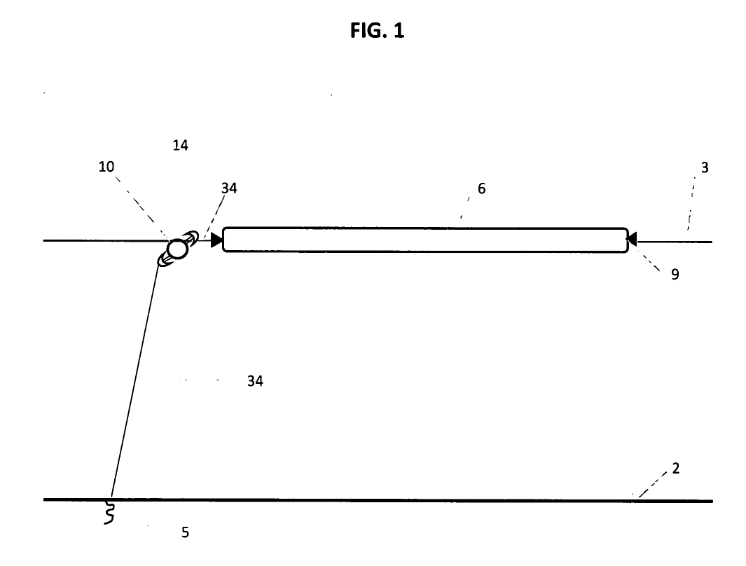

### First Embodiment: The Surrounding Bag (FIG. 1)

The First Embodiment is a cylinder mesh 6 that has an aperture of half inch. It has a diameter of seventy meters and a length of five hundred meters. At each end of the cylinder the whole mesh is tied together with a piece of rope. One end 9 is not fastened to any object and the other fastens to a sturdy metallic floater 10 with big cleats 14. One sturdy rope 34 ties the floater 10 to one strong mooring helical screw 5 attached to the seabed. The bag moves according to the waves. The cylinder mesh in the water with the Sargasso mass flattens the structure to a width of one hundred five meters. There is no need for the net bag to have floats, since the Sargasso floats by itself.

Used against oil spill. They can be left at the sea in strategic positions and close to offshore drilling. In case of an oil spill many surrounding bags can be tied together as a train car and dragged together to the spill by a fast ship. Once close to the area of the spill the bags are emptied by simple untying the rope at the end 9 of the surrounding bag and keeping the ship moving. The Sargasso should be placed in such a way that the currents forces the seaweed to interact with the oil spill. After this happens, very shortly the Sargasso sink to the bottom of the seabed.

Used as a shore shield. The structures can be placed a kilometer away from the beach as a precaution. In case of a hurricane or big storm they can be used in diminishing the destruction done by the waves once the storm hits. Homeowners would like to have these structures one hundred meter wide being placed between the sea and their homes during a storm. To put them in place they need to be untied from the anchor point and placed parallel to the designated beach. As waves grow stronger they will move the bag closer to their homes. They will always diminish greatly the strength of the waves.

Used to grow Sargasso. The advantage of this net is that regardless of the wave's strength, the seaweed stays inside the net bag. So it can be used in the east side of Florida where waves are much stronger. After establishing where the seaweed is going to be used the bag will be placed in a way that once the bag is opened, the currents and the waves will bring the Sargasso to the designated place.

Used as transportation. The structure does not need to be filled completely with Sargasso. A boat will drag the mesh and deliver the Sargasso. During the trip the Sargasso mass keeps duplicating. So considering the distance in time of the trip we establish the amount of Sargasso to be loaded. The structure can be fixed to the opening of the Sixth Embodiment “the large cage” so that the waves force the Sargasso to fill this structure. Once the structure is filled both structures, the large cage and the surrounding bag are closed and a boat drags this structure.

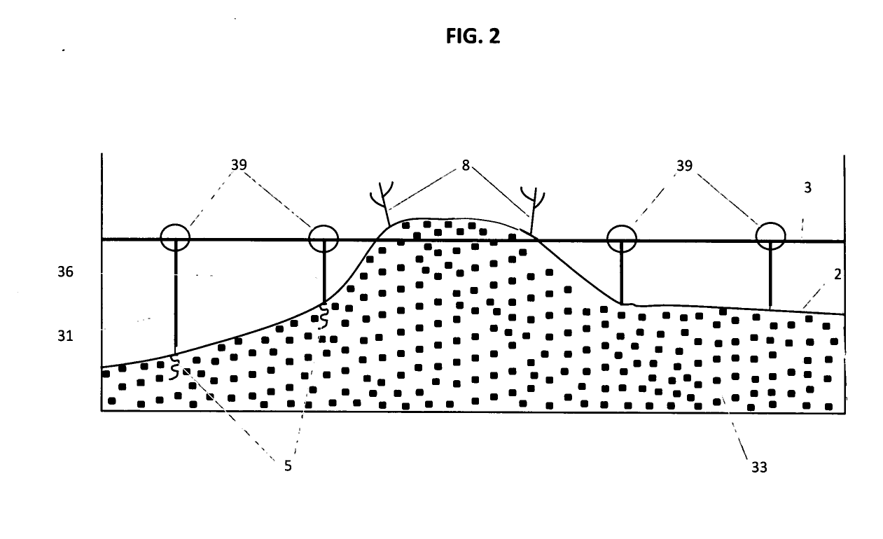

### Second Embodiment: The Surrounding Island Structure (FIG. 2)

These Sargasso nursery structures are ideal to use in South West Florida, in islands that are sinking under the rising level of the sea. The rising of the water wash away soils structure leaving an inert island. The size of said structure has to be at least five times the size of the island. The structure surrounds the island but it is eccentric. The bigger extension of the mesh area is towards where the most predominant waves and currents come from. The dock of the island is also not surrounded by the mesh. The structure consists in a continuous tubular floater 39 made of an uninterrupted rope covered with foam. A mesh 31 is fastened to the floater with pieces of rope. At the bottom there is not a separation between the sea bed 2 and the mesh. Short pieces of rope fasten directly the mesh to helical screws 5 dug into the sand.

If this embodiment is used in a rougher sea, the height of the mesh should be higher than the distance between the seabed and the top of the waves. A heavy wire or a chain threads the surrounding mesh one meter above the seabed. The weight drags the chain to the seabed, however the waves will make the floater to stretch the mesh and lift the chain, keeping the floater above the water and restraining the Sargasso inside the structure. After the wave pass the weight put all back in order.

Sargasso is placed inside the net. The mesh avoids the Sargasso to be washed away by the waves. There is also an internal mesh 36 surrounding the island a few meters of the beach. This mesh prevent that waves wash away all the Sargasso over the islands, leaving the structure empty of living Sargasso. Eventually the Sargasso will fill all the space and new growth will cover the old Sargasso. Every twenty one days the seaweed will double its volume. Very soon the layer of mass of seaweed gets thick. Sargasso thrives up to five feet thick in the sea. As the seaweed continues growing, deeper than 5 feet the light will be too scarce. There is a point that the growth of new seaweed is the same as seaweed which dies and sinks. As this process is relatively very fast, and the waters are shallow, the accumulation of dead seaweed 4 at the bottom starts raising the level of the bottom of the seabed until there is not separation between the dead and living seaweed. Red mangroves seeds-propagulus 8 should be planted surrounding the island a few meters above sea level in order to protect the structure of the island.

This and all the following embodiments can be made with the standard material used in ocean cage aquaculture. (industrialnetting.com) however the material is expensive. In an intensive fish farming profit oriented enterprise, the price is recovered soon. In contrast, my structures are extensive farming so the idea is to create huge extensions cages at low costs.

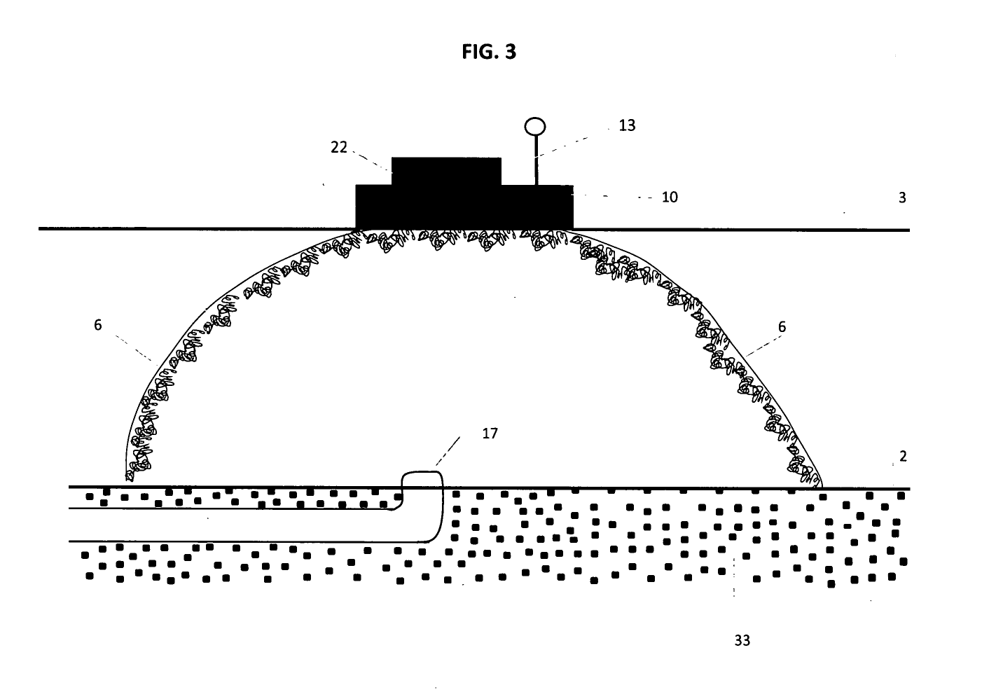

### Third Embodiment: The Filtering Dome Shell (FIG. 3)

This embodiment comprises of a dome shaped net that filters the effluents from the cities. South East Florida land is very expensive and overcrowded so in small piece of land they have to treat all cities' effluents in a short time. There are four open ocean outfalls 17 Miami central, Miami North, Hollywood, and North Broward which discharge the pretreated waters of the sewage system. Sargasso nursery structures would surround these outfalls in order to filter and absorb all the effluents, and eventually replace the inland sewage treatment plants.

The periphery of the dome shaped mesh is fastened to the seabed with mooring helical screws 5. The top has some floaters 10 with a small solar panel 22 and lights 13 and at the center of the dome at the seabed there is an outfall 17. The Sargasso mass grows and covers most of the space inside the dome. The light is filtered through the layers of Sargasso, limiting its growth. Resulting in the Sargasso growing close to the net and not in the center. All the effluents are filtered through Sargasso that absorb all nutrients, limiting the growth of pathogens and cleaning waters from pollutant. They are very efficient in absorbing heavy metals.

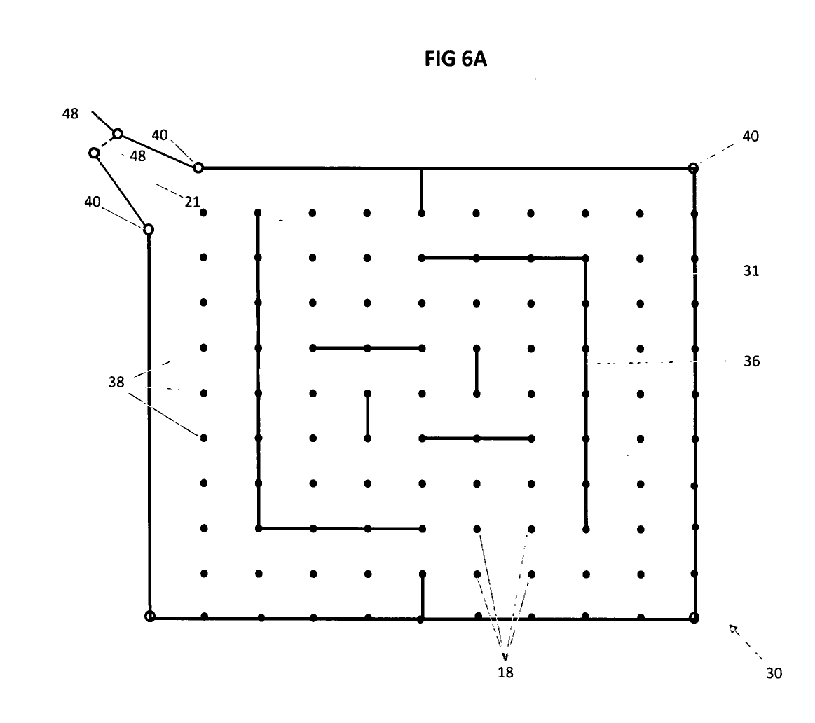

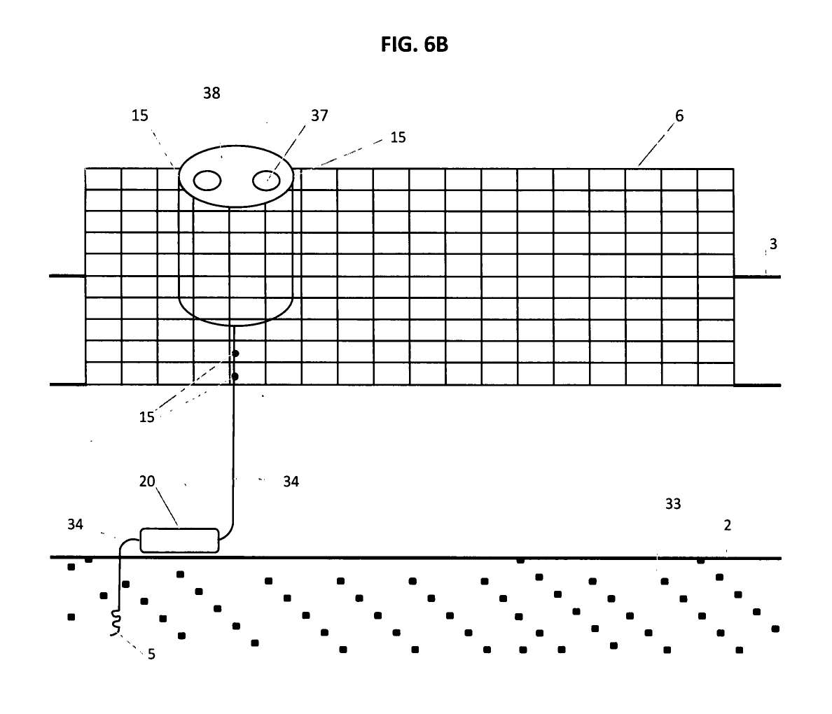

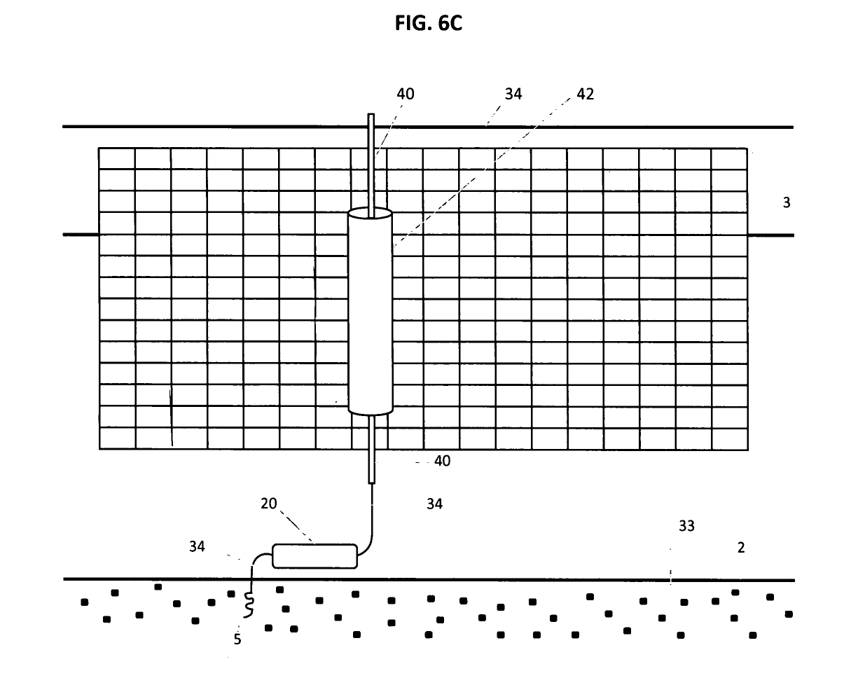

### Sixth Embodiment: The Large Cage (FIG. 6 A, FIG. 6 B, FIG. 6 C)

The shape and size is in accordance to the location. In this case I will describe it as a cage with a shape of one kilometer squared with four inches fiberglass rods 40 covered with pipe insulation at every corner fastened to the seabed. This maintains the mesh 6 stretched. Extra fiberglass rods 40 would be added in places where there are big waves or currents.

The structure has anchor points every hundred meters in both, width and length, creating a grid 18 of squares. Every anchor point consists of helical screws 5. There is a plastic rope 34 with two ends. One ties to the helical screw 5 and the other ties to a weight 20. Another rope ties one end to the weight 20 and the other end ties to the bottom of a fifty five gallon plastic drum 38. These sturdy three feet tall, empty standard plastic drums are used in many industries and are freely given. They are placed vertically and one fourth of the drum is filled with water. So the drum floats but still one fourth of the drum remain under water. In order to use the drum as floaters, we drill a hole at the bottom center of the drum and the end of the rope 34 is fixed with a knot to the drum. One of the two small upper standard lid is opened and used as an exit point for the rope. A double knot is tied to the end of the rope 34, as it is pulled from the other end it cannot exit and remains fixed to the hole at the bottom of the drum. We screw the lid 37 back on the drum. At the top one inch brim of the drum we drill holes in order to attach the upper end of the net with carabiner hooks. This allows easy access to unfasten or fasten the net. At the bottom the drum the net is fastened to the anchoring rope using carabiner hooks. The structure is formed by four external four feet high meshes one kilometer long. The meshes have carabiner type hooks 15 at the borders and at the ends to allow changing the shape and the size of the structure as needed. It also has some internal floating meshes 36 that are placed as needed. They are built exactly as the external. The net is attached to each plastic drum in a way that half of the net stays below sea level and half above sea level. The waves force the rope to lift the weight 20 but the drum 38 keep afloat. The external meshes do not allow the Sargasso to exit the structure. The internal meshes never enclosed totally the Sargasso in an area. They force a more regular distribution of Sargasso inside the structure, avoiding waves and currents to pile up the Sargasso in just one sector, but allows it to flow.

Another different way to build the external and internal meshes is using one inch fiberglass rods 40 placed in vertical position. Those rods are used to build fences. The bottom half of the rod stays under the water and is covered with pool noodles 42 or industrial pipe insulation. The height and diameter of the rod, the height of the mesh, and the pool noodle or pipe insulation is in relation to the height and strength of the waves. Drums have great buoyancy strength and rods have a greater height. It is a good practice to alternate them when building the external walls.

These standard rods already come perforated at the top and at the bottom. The bottom hole is going to be used to tie it to the weight 20. Some wires unite the top of the rods of the external mesh. Other wires unite some rods of the external mesh with rods from the internal mesh. Being the rods tied at the top, give the structure more cohesion to stay standing regarding the waves.

At the farther end to the coming currents the external mesh has a shape of a funnel 21 that is normally closed by a retractable ninety eight meters wide mesh 48. And at the time of collection the closing mesh is open. The currents helps the Sargasso to leave the structure and be collected by the First Embodiment the surrounding bag.

The entire Florida Gulf of Mexico Coast is suitable for installing these nurseries. The seaweed can be produced here in these nurseries areas. And the current can be used to deliver the Sargasso far away, to a desired location.

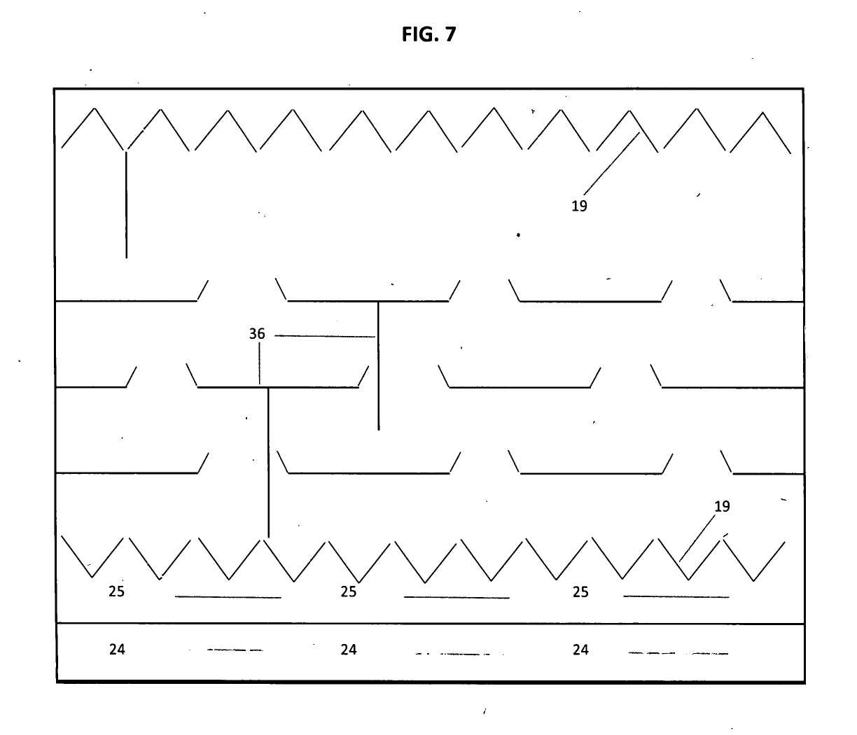

### Seventh Embodiment: The Barrier Protective Stripe (FIG. 7)

It is a modification of the previous embodiment, using all the same components: helical screws 5, ropes 34, weight 20, fifty five gallon drums 38, meshes 6, rods 40, pool noodle 42. But instead of having a square shape it is a stripe five hundred meter wide and kilometers long. The protective stripe protects the shore barrier's embankments (see page 30) from the waves. Those two are parallels with a separation between them of fifty meters, called the buffer zone. The protective border that faces the shore barrier's embankments. The external border, instead of having an uninterrupted linear mesh, is formed from many pieces of mesh in a “V” shape 19, so that the incoming waves force the Sargasso adrift to enter the structure. However in the opposite direction the “V” shape mesh 19 acts as a trap for the Sargasso. There are also many internal meshes that help retain the Sargasso in the stripe and also distributes the Sargasso evenly, regardless of the waves and currents. So the Sargasso grows uniformly in the stripe. The internal border of the stripe also is made by pieces of mesh with the V shape 19 in the opposite direction. So Sargasso is retained in this stripe and only leaves when the stripe is completely filled with Sargasso. Every twenty one days all the Sargasso duplicates the mass. Then the mass will cross the internal border and accumulate in the buffer zone. It will become a thick layer of dead seaweed and its debris. As time passes the accumulation of Sargasso will make the layer sturdier and thicker, expanding its width instead of deteriorating.

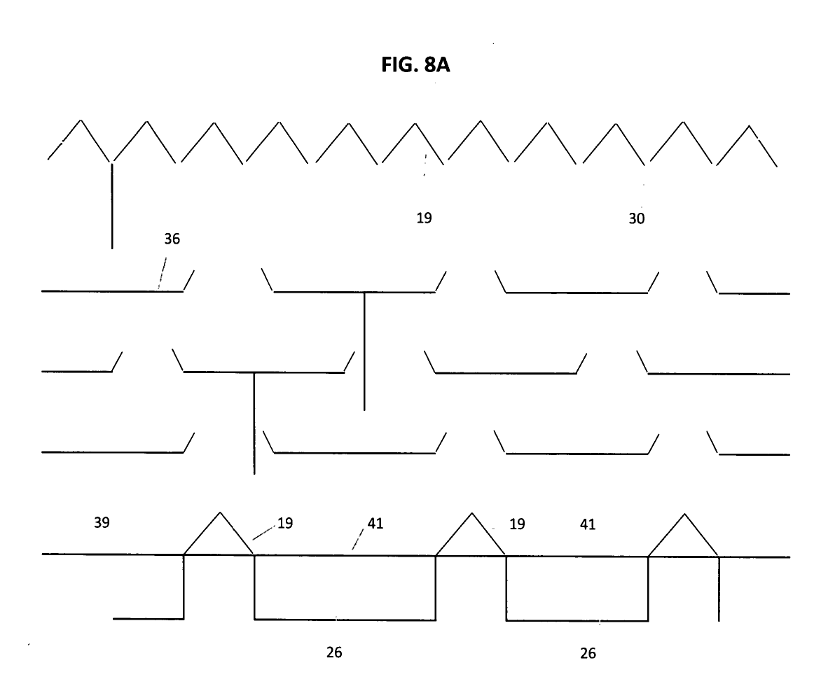

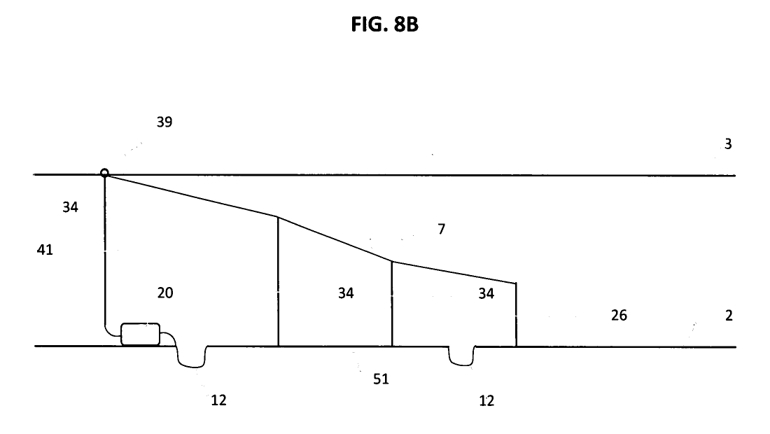

### Eighth Embodiment: The Sand Bar Formation Stripe (FIG. 8A, 8B)

It is a modification of the Seventh Embodiment. Instead of it being placed to protect a shore barrier's embankments, it is placed by itself. The external border and the internal meshes (no border) 36 are exactly equal as the previous embodiment. The internal border is different. It is placed where the sea is two meters high and consists in an uninterrupted mesh, that alternates pouch shape meshes three hundred meter long with meshes in “V” shapes 19 thirty meters long. The pouch shaped mesh, rest sideways on the sea bed and has an upper 7 and a lower side 51 and the bottom of the pouch 26. The lower side lies on the seabed 2. Two meter long pieces of plastic rope 34, tie intermittently the lower with the upper side. The height of the pouch is two meters and its depth from the entrance of the pouch 41 to the bottom of the pouch 26 is fifty meters. The lower side of the pouch net is anchored at the entrance and at the bottom. Since so many anchor points are required in the same line, it is better to create two lineal anchor ribbon 12. A dredge will make two trenches three hundred meters long and thirty meters apart. The lower border of the mesh and the bottom of the pouch net 26 are buried into the trench. A piece of plastic fabric one meter wide is placed above the net. Later the plastic fabric is covered with sand, filling the trench. The border of the upper side is kept afloat by a continuous tubular floater 39 made off a rope covered by foam, which is tied first to a weight 20 and after the rope is tied to the lineal anchor ribbon 12.

This mesh pouch shape three hundred meter wide is separated from the next one by pieces of meshes in “V” shape 19 with its vertex directed to the open sea and the others two ends are tied to the pouch mesh. They are formed in the same way as the previous embodiment.

Operation: The waves force the Sargasso adrift to enter into the stripe and it is trapped inside the stripe. The internal meshes keep Sargasso growing uniformly in the stripe. When it is filled with seaweed, as Sargasso continue to grow it will exit and waves will force it to enter and sink into the pouches. The “V” shape nets also divert the Seaweed into the pouch net. The waves will push the seaweed against the seabed inside the pouch. As the seaweed debris continue to accumulate and sand deposits filling the holes inside the seaweed matrix, inside each pouch a sand barrier will start forming and rising. The water is going to pass over the sand bars and will return to the ocean through the V shape nets 19. The seaweed debris will continue accumulating creating resistant sandbars that will withstand the storms and eventually become barrier islands.

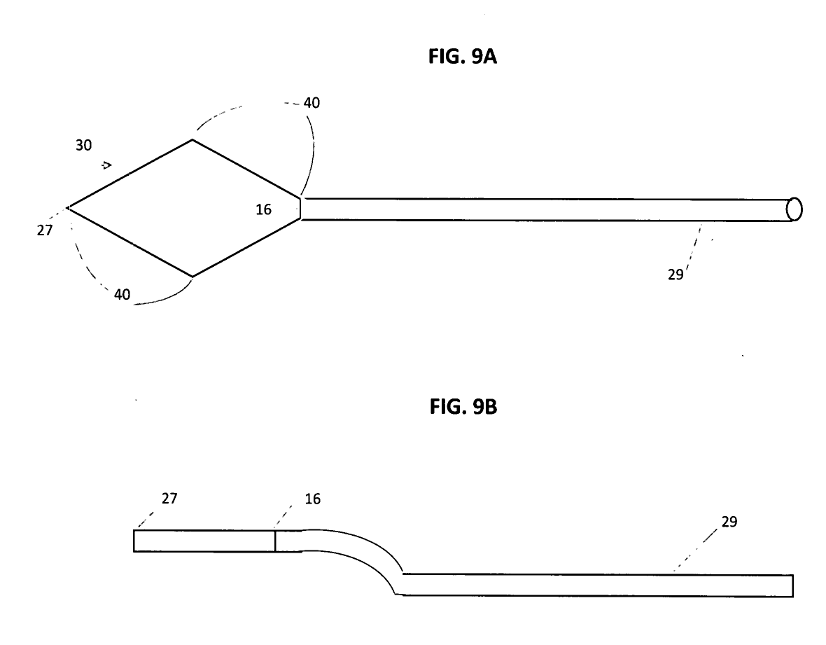

### Ninth Embodiment: The Kite Shape Structure (FIG. 9)

It is a modification of the Sixth Embodiment with a kite shape. At the four corners of the kite there are four inches fiberglass rods covered with pipe insulation. The rods are anchored to helical screws with ropes. The point of the kite 27 is directed towards where the currents or waves come from 30. At the opposite extreme there is an expandable opening which adapts to the length of an adjustable rope 16 that surrounds the opening. This opening is connected with an anchored tubular shape net 29. The size of the kite and diameter and length of the tubular net will be in proportion to the production of Sargasso.

Operation: Once the kite structure is filled with seaweed the opening is regulated in such a way that the kite structure is filled with seaweed, but the excess is guided by the waves to the tubular net. Wherein the lack of light, nutrients and oxygen, and the pressure of the waves, they will soon die and accumulate at a determined place. If well planned, the kite can be placed really far away from the shores. The waves will carry the seaweed inside the tubular net to the desired area. This structure can produce Sargasso as filler of the shore barrier. So there is no need of transportation, the structures deliver the Sargasso regularly where is needed.

### Twelve Embodiment: The Fixed—Mobile Nursery Structure

This is a Sargasso nursery structure and also can work as transportation in calm waters. It consists in a long mesh. The mesh forms one side wall, the floor of the cage ant the other lateral wall. The mesh every 5 meters has at both sides five feet rods covered with pool noodles tied to the mesh. The top of the rods are tied together with the rods from the other lateral wall. The width is one hundred meter and kilometers long. At the beginning and end there is also a mesh 4 feet tall. The structure is filled with some Sargasso. And after a while, one boat drags the mesh and delivers the Sargasso.

This roofless structure are suitable for transportation in calm water and in short distances. But its construction uses less amount of mesh.

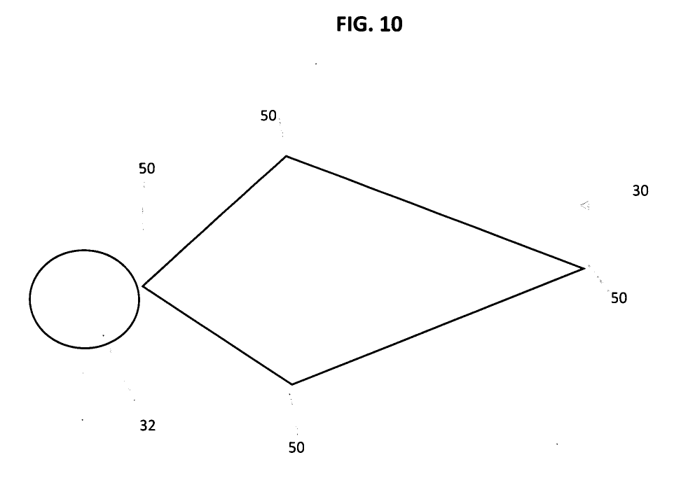

### Thirteen Embodiment: The Attached Kite (FIG. 10)

This simple kite structure is placed always completely in the sea water and by the side to an existing islet or a low rocky land in the sea. The purpose of this structure is to rise the soil level of the designated land. One edge of the kite structure is adjacent to the land. The four edges have pretreated wood poles 50 perforated at the top. The four of them are buried in the sand. They need to be higher than the waves of the area. One tense solid wire goes through the holes at the top of the rods, connecting the top of the four fiberglass rods. The net attaches to the fiberglass rods and to the wires at the top with carabiner hooks and the bottom the mesh is attached to the seabed using helical screws. Sargasso grows inside the structure and covers all the surface. The waves will push the seaweed against the land. Sargasso will accumulate in the adjacent edge where living Sargasso will be floating and underneath the dead Sargasso will become a sludge. A suction jet pump will throw the Sargasso, the sludge and water on top of the low land.

Previously the periphery of the land to be filled is elevated. These walls can be built with natural adjacent rocks like it is currently done in Singapore. Also concrete walls can be built too. Many islands are bare rock and rise a few feet above sea level and are uninhabited. In Hawaii volcanoes creates rivers of lava that will take hundreds of years to be fertile again. This structure allows to rise the soil level ten meters and create a paradisiac island or ocean view land where to live.

Sargasso Process of Cultivate, Delivery and Use

So far, I described the nursery structures with some features to use in several scenarios and to accomplish different functions. Now, using these structures I will give detailed specifications and benefits of a holistic process of cultivate, delivery and use of Sargasso.

The design of the nursery structures has two points in consideration. First: the structures are able to produce a giant mass of Sargasso. Second: the structures are made with simple and affordable materials. The “Farming Sargasso” method goal is to produce regularly and to deliver with very low costs huge Sargasso mass to a designed place and use it there.

Two important conditions are that the activity has to be profitable and ecofriendly.

Being able to harvest tons of vegetable mass without using fertilizer, nor pesticides, without paying any rent for land use, that at the same time benefits the environment, is definitely an innovative process. If the Sargasso mass needed to be transported in a truck to the destination, it will probably not be profitable due to its shipping cost. However, transporting hundreds of tons of Sargasso mass without the shipping costs is what makes the process even more innovative.

Delivery

The Atlantic Ocean has cycling currents. At the Gulf of Mexico, there is a current called the Gulf Stream. It is typically one hundred kilometers wide and has a speed of 5.6 mph. It forks into two branches which are the Caribbean Sea current and the Antilles current. The first one goes West, close to the Venezuelan shores, and then follows the Eastern coastline of all Central America, Mexico, Texas, Louisiana, Mississippi, Alabama, Florida and crosses the Florida Keys where it rejoins with the Antilles currents. Then, it turns East and North passing between Florida and Bahamas and goes North, following the Eastern coastlines of the United States, until it reaches Newfoundland. The Sargasso is carried by these currents naturally.

This method delivers huge amounts of Sargasso mass in its mesh encasement using the currents. The mass can be towed by ships at very slow speeds, taking advantage of the energy of the Gulf Stream current and using the power of the boats only when needed. Even though the best place to growth Sargasso is in the warm waters of the Gulf of Mexico, big amounts of Sargasso mass can be delivered all the way north to the State of Maine.

The rising sea levels are forcing those living in the Atlantic shores to grapple with the impacts of climate change. Homes are being slowly washed away and shores are being deteriorated by the sea. Scientists predict sea levels could rise 39 inches by 2100. According to Dewberry & Davis 1986, 540 cubic feet of sand per linear foot of dune is required to resist a 100-year storm (FEMA 540 rule). This indicates that almost all Atlantic shores are in peril if one big hurricane hits shore and brings flooding with it. Sand is a needed commodity for the construction industry. Moreover, as the sea level rises, there is not a resource at hand that can cope with the disaster. If sand is dredged from another place and diverted to the beach, very soon after a storm, the sand is washed away back to the sea. A new resource is needed, but not available at this time.

Eighteen thousands years ago, during the most recent Ice Age, Florida's width was double than what it is today. The rise of the sea levels a few meters high has shrunk Florida's land mass to half its size. The Sargasso nursery has the potential to fill that space and create elevated soil to protect the existing Florida land and the potential increase of Florida's land mass. Overpopulation seems unstoppable. The oceans cover seventy one percent of the Earth surface. Being able to create new fertile lands would be ecologically friendly and a great natural resource.

Sargasso mass is the new commodity, and replicates its own mass every twenty one days. It thrives in Mexican Gulf waters, which is a vast area, rich in minerals and nutrients. The production of Sargasso would clean the polluted waters and would be a sanctuary for sea life. So, Sargasso is the new resource to raise the shores and fill the core of sea barriers.

Shore Barrier Embankment

The West Florida Coast shoreline has a gentle slope and almost no waves, being the ideal place to create wide shore barrier embankments. One requisite however is the existence of a huge nursery Sargasso area.

There are many island barriers that are narrow sand settlements parallel to the shores and lower than three feet tall. They are very important in protecting the shores, but they are made out of very low sand formations which are affected by waves and currents.

Description: Wide Shore Barrier Embankment is a term that I employ to describe a new artificial land formation. They are ten meters above sea level and kilometers wide and kilometers long parallel and bordering the shore. When planning them is important to consider not blocking the harbors and properly connect these corridors with mainland where there are already roads. These embankments have a “T” shape from an aerial view. Wherein the base of the “T” is connected and perpendicular to the shore and is three hundred meter long into the sea and two hundred meter wide. Then the barrier turns ninety degrees in both sides and become parallel to the shore and wider. The depth of the sea level will limit the width of the barrier. In some places in West Florida, it can be five kilometer wide.

Construction: It is convenient to start constructing this artificial formation from the shore to avoid loading heavy equipment in ships so the compactor/roller can advance compacting from the mainland. The building process entails in longitudinally dredging a channel in the sand. The width of the channel will determine the width of the embankment. The sand dredged is accumulated at both sides of the channel constructing two parallel sand barriers that are at least five meters above sea level and with twenty meters width each. It is convenient to add Sargasso mass to the pile of sand to give the sand barrier more structure and fertility. Roots plants will thrive in this mix making it sturdier. The filling of the dredged channel employs very similar techniques used in sanitary landfill. After the barriers are built, Sargasso mass is brought inside to fill completely every space between both barriers. Promptly a new sand barrier closing the two parallel barriers and enclosing the Sargasso mass is built, creating a sea pond. Huge amounts of Sargasso are poured over. Sargasso will die soon. The pond content, as Sargasso is added, will become a thicker sludge then muddy and finally it will solidify. Rollers coming from the mainland will compact the soil. The pressure from the roller plus the weight of the mass above sea level will make that water to go in the direction of the ocean. Once this becomes dry and it is at least two meter above sea level, an agro plastic film can be placed to separate good soil from sea water infiltrations. Thereafter, more layers of Sargasso will be added, the goal is to raise the soil level at least ten meter above sea level. It is convenient to create the barrier with a considerable width. The reasons are that the width gives solidity to the structure. This is because, when dredging a wider longitudinal channel, there is more sand to pile in the sands barriers. The construction is a process of three steps: first, dredging the sand, second, filling with Sargasso, and the third one is compaction with heavy equipment. During the construction of the shore barrier embankment the three steps happen at the same time, but in different places. Some pipes regularly should be inserted in the Sargasso mass to allow the evacuation of gasses created during the decomposition.

The external side of the external sand barrier can be protected with the Seventh Embodiment, the protective stripe, described above. That means waves before smashing the barrier cross five hundred meters of living Sargasso producing ceaseless amounts of Sargasso that deposit protecting the sand barriers. Otherwise will be protected temporarily, anchoring a big plastic webbed fabric. The internal barrier will serve as a dock for boats. There is a tendency for people to live in boats. The barrier will be rich in wildlife. The original beach will remain the same. It will have less waves. The external barriers will receive all natural Sargasso adrift and everything floating in the water. The waters and beaches will be clear of Sargasso and other debris after the barriers. The shapes of the barriers could be designed according to local needs.

The soil formed with the Sargasso is very rich and complete in nutrients. However when organic or inorganic Nitrogen is added to the soil the plant growths incredibly. In order to incorporate more organic Nitrogen to the soil, tropical legumes vine seeds will be sowed. These Phosphorus demanding plants will thrive in this rich soil, creeping and covering the soil. These legumes are able to fix Nitrogen from the air to the soil.

The soil, besides being so rich in macro and micro mineral, acts like a sponge retaining water and is airy at the same time. These plants with their extensive root systems will protect the soil from strong winds. This soil is completely different to the sandy soils found on the beaches.

Mangroves roots planted in the sand barriers a few meters above sea level are extraordinary to smooth the strength of the waves. The nutrients of decomposed Sargasso will infiltrate the sand and nourish a healthy population of mangroves protecting the sand barriers under the calm waters of West Florida.

Pineapple plants don't grow in mainland US. Maybe South Florida is the only place in mainland US where weather conditions can allow pineapples to growth. However, the land in South Florida is too expensive and the soil is too sandy and lacks nutrients. All pineapples varieties can thrive in a soil made with Sargasso using my method. This is a huge industry that can bring a boost to Florida's economy.

Gaining ground in the South Florida shores, extensive and intricate gulf courses in the most expensive areas can be designed, as well as recreational parks and sport fields.

The East Atlantic shore and the Bahamas are exposed to stronger waves. It is convenient to construct the Shore Barrier Embankments with a slight design difference. The external barrier that receives the pounding waves needs to be constructed with harder materials such as rocks, concrete walls or Purloc sheet piling systems. They need a shield made of a sturdy material that will not be erode by the waves. After that shield is created, they are filled with tons of drained and compacted Sargasso. The height and weight of the compacted Sargasso provides solidity to the structure.

Solidifying, Widening and Bringing Fertility to the Dunes.

Another way to protect the shores is rising, widening and solidifying the dunes, if shores barriers is not the desired final product. The dry sand is very susceptible to wind erosion, rain and waves. The Sargasso mass will stop this.

Stronger, higher and wider dunes will be creating by mixing humongous amounts of Sargasso with sand. This step will be repeated when needed. The resilience to erosion of this new dune will be given by the height of the added mass, by the physical resistance of the matrix sand-Sargasso, and finally by the formation of a belt made of sturdy vegetation. This new soil is over rich in nutrients and has a great capacity to retain humidity making it perfect for plant growth. It will be made by digging a wide and deep trench parallel to shore. Sargasso mass is used to fill it and the sand is used to extend the beach towards the ocean. A high level green belt is created between houses and the beach.

Water reservoirs are an important part in the project. Some living dunes will have in one side Sargasso compost and on the other side a water reservoir. Since it is all land gained to the sea, it is important to consider water reservoirs for watering, human consumption and huge pools for tourist attractions. They must be almost empty before the rainy season. In New Jersey they build high dunes barriers parallel to the beach for protection. The result was that during heavy rains, the dunes barriers blocked the drainage of the rain water. However with proper planning it is possible to have it all, creating living dunes at the beach with lateral drainage that conducts the rain water to the water reservoir.

It is important to consider a drainage from the land to the ocean. Netherlands has successfully created the “Polder” for land reclamation consisting in strong and tall concrete walls and pumps. During heavy rain, the pumps take the rain water to the oceans. The same process can be created using Sargasso walls instead of concrete walls.

Sandbar and Barrier Islands

Sandbars occur naturally in the ocean as lineal narrow deposits of sand parallel to the shore. There is a deep area called trough, after the sandbar. Perpendicular to the sandbar and the trough, are the cuts. The cuts are deeper channel where the water brought by the waves comes back to the ocean.

All of them are very important to absorb and dissipate the waves' energy, avoiding the impact in the shores. However, they are very unstable because when big storms come, strong waves make the sandbars disappear, and hurricanes make disasters.

In all East Florida at hurricanes times the shores suffer flooding and destruction. However using the Eighth Embodiment (the sac shape stripe) resilient sandbars and later barrier islands can be created. During planning stages of the model, it is important to design it in a way that some part of the sea is enclosed. It is also crucial to take in consideration the existing sandbars, troughs and cuts. The Sac line entrance should be anchor after a deep natural sandbar, ideally around six feet deep. There will be a permanent accumulation of seaweed at the bottom of the sac because the sand flows and comes back with every wave. The expanding mass of dead seaweed will create a matrix for sand to fill the holes. The waves pressure compress the seaweed against the seabed and it is also retained by the mesh. Sandbars happen naturally. The addition of the expanding seaweed matrix to the existing sandbar and the sand filling the holes will create sturdy sandbars to withstand heavy storms and eventually becoming island bars.

The uninterrupted mesh and enclosed area will create a beach clear of seaweeds, sharks and any other big fish. Clean beaches, clean waters and the reassurance of no sharks will make these beaches very popular for tourists. Local business will the increase their profits and have less losses by flooding. Moreover, three hundred meters away from the shore, unnoticed by tourists, another happy community of wild life in many forms will thrive at the sac shape stripe.

Isles and Rocky Areas by the Seas

Either in an island, an islet, or a rocky soil by the sea the goal is to elevate the soil, create a hard shell and fertile soil. In order to create a hard shell, its strength is related to the coming waves. The purpose of the shell is to avoid that the rain and the waves wash away the seaweeds. Accumulating rocks in the periphery taller than the waves is a way to do it, another approach is using concrete walls. A more ecological technique is to install a wire fence that holds temporarily the Sargasso mass. Time needs to pass by until the mass settles and becomes a rich soil. Red mangrove propagules should be planted in the periphery. They will develop in strong trees with interlaced roots that will also anchor in the cracks. Once the land is filled with Sargasso, the structure should stay in place for stability. It is better if it outstrips the soil level, and time to pass by for the trees to grow and the rain settles the soil. It is also convenient to add another layer of Sargasso every year, before the hurricane season.

So far I proposed different Sargasso Nursery Structures associated with raising the soil level of an island. Now, I will explain four different real sinking island and why I will chose one or other embodiment.

A. Chandeleur Islands and Isle de Jean Charles, Louisiana. This area is great as a Sargasso nursery but there is too much ship activity. Instead, the currents of the North West exit of the Pensacola-Clearwater nursery model described below, can supply huge amounts of Sargasso in a short and safe trip.

B. Scattered Islands in Monroe County Florida. These are tiny island scattered in South West Florida, a place with very low waves. Parts of the islands are gradually sinking. Homeowners in the island can use the Second Embodiment to change the sinking and raise the soil level of their island.

C. Kapoho area in Hawaii is now inhabitable. Huge areas by the sea are covered by rivers of lava. To naturally develop back fertile soil will take more than one hundred years. The Thirteen Embodiment, the attached kite, can create rich soils in less than a year. Since Hawaii is far away from Florida, it is convenient to start with a clean strain of Sargasso and then use the Thirteen Embodiment.

D. Ragged Island in Bahamas is an impoverished island dedicated to the salt industry. After hurricane Irma residents were evacuated. Due to being a small island in a rough deep sea and out of reach for the Gulf of Mexico current, the First Embodiment will be chosen (the surrounding bag) When the bags are filled, two thirds of Sargasso mass is poured over the land. Then the bags are closed and after a month period the process can be repeated.

E. Andros Islands in Bahamas has a huge area where the soil level is only one meter above sea water. Huge amounts of Sargasso mass can be delivered from the Pensacola-Clearwater nursery or another huge nursery can be created locally in shallow waters.

Just to highlight the significance of the activity, nowadays a private Caribbean island with the soil level just above the sea level is worth many million dollars.

There are many places in the Caribbean Sea where with my method, high fertile soil level islands can be built at low costs.

Other Uses of Sargasso

Fish Nurseries

National Fish Hatchery System has been very strict allowing sea fish nurseries, mainly due to pollution. Associating living Sargasso with fish nurseries is a win-win situation. Sargasso will absorb all pollutants and grow and fishes will have purer waters and a place to spawn and forage.

Restrain Oil Spills

Big extensions of growing Sargasso in “surrounding bags” (First Embodiment) are a fast first line to buffer against oil spills. The bags can be towed to the area, as described in the First Embodiment, and when the Sargasso gets in contact with the spilled oil, it absorbs it and sink to the bottom of the sea causing a lesser impact on the environment.

Bulk Fertilizer

American soils are depleted of nutrients and fertilizers are expensive and contaminating. In Florida, Sargasso can be used in citrus trees. Sargasso has all macro and micro nutrients and not an excess of Nitrogen so it is ideal for fruit trees in production and not for vegetative growth. Due to its richness in nutrients, it can be used in hydroponics and in demanding and expensive crops. Sargasso can be used as mulch since when it is dried, it is sharp for snails and disliked by many insects but full of nutrients for the plants. It can be compressed and dried in a particular shape like a tile making it easier to handle.

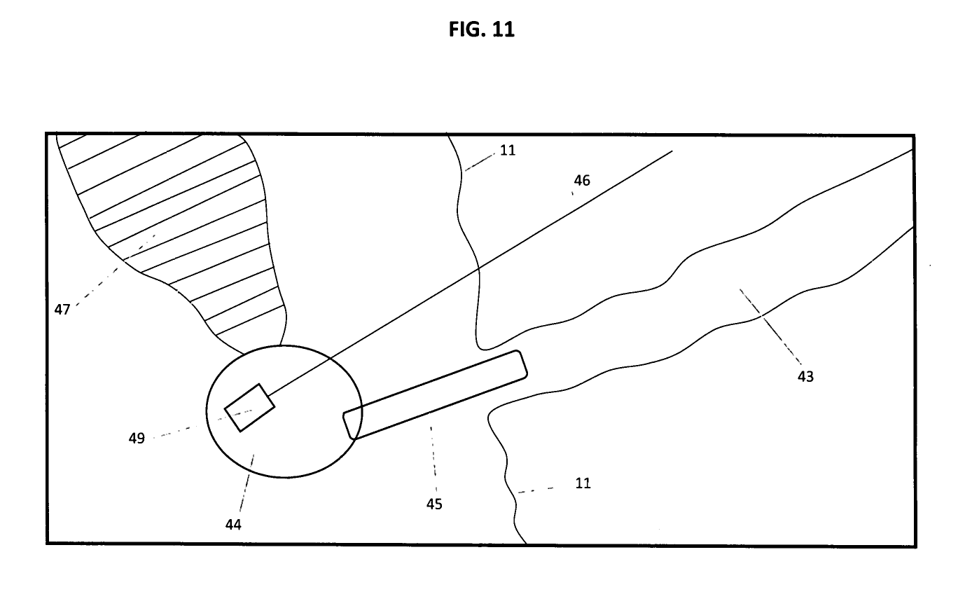

Liquid Fertilizer (FIG. 11)

Sargasso cannot live in freshwater because it does not tolerates the lack of salinity so it dissolves in the fresh water becoming a thick sludge that can be pumped to land and used as a fertilizer without any cost of shipping. Using the shore barrier embankment techniques it is easy to build big ponds 44, close to a river mouth, at the sea that will act as “Sargasso liquefying plants”. A wide pipe 45 will connect the river bed with the pond and fill the pond with fresh water by gravity. The Sargasso nursery structure associated with this activity will use the currents and waves to accumulate Sargasso by the pond. Through trawling techniques the Sargasso will end in the pond. At the bottom of the pond there is a wide flat filter that retains debris but lets the liquid get through. A pump 49 and a pipeline 46 will send tons of liquid fertilizer thousand feet away that can be used in the farm, in hydroponic or bottled up.

Animal Food

Sargasso can be processed and mixed with grains to make pellets for cows, chickens and pigs. Chicken beds can also be made with Sargasso.

Ecological Point of View

As stated above, NOOA designated the pelagic seaweed as Essential Fish Habitat that resulted in a phase-out of commercial harvesting in U.S waters. My Sargasso nursery structures don't harvest wild Sargasso. It only needs a strain and starts duplicating. All wildlife that live, feed, swam, hide in Sargasso will have thousand time more habitat to grow. So the amount of specimens will also reproduce by thousands.

Fishing nets are made with colors that fish and wild animals don't see. However, my proposed mesh is ultraviolet green color so they can see them. Once in a while, unfortunately, a specimen will get trapped in the wall net. However the amount of other individuals from the same species will increase by thousands.

Innumerable fishes die when red tides expand in the sea waters, and fishes become dangerous for consumption so the fish industry stops all activity. Huge areas of sea covered with Sargasso will absorb nutrients, and purify the sea waters, competing and controlling the occurrence of red tide.

Greenhouse Effect

Although it is well known the harm of the increasing carbon dioxide in the atmosphere, human activities keep producing more gasses and deforesting, making more lands to become arid. The Amazon Jungle is depleted year after year. Big extensions in the sea of growing Sargasso will absorb Carbon dioxide from the air and produce seaweed mass.

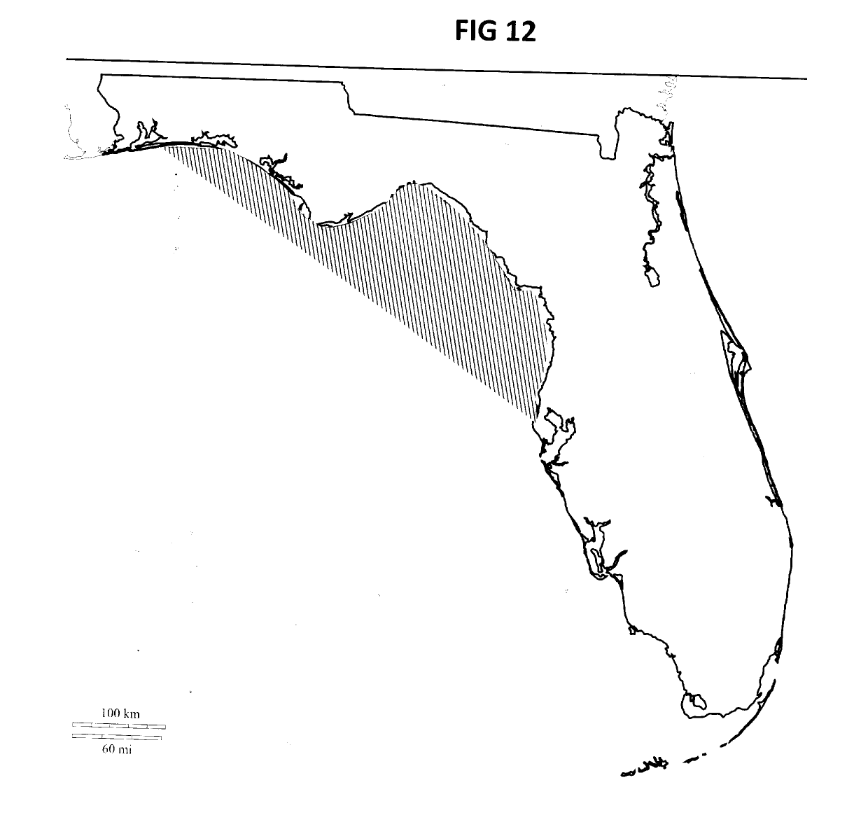

Pensacola-Clearwater Nursery Model (FIG. 12)

Now I will explain how the embodiments described above work together in a real case scenario. In the North East Gulf of Mexico there is an ideal area to grow Sargasso. There are many facts that nobody recognize, but are the best conditions to place my nursery structures. Such as:
1 The Mississippi River basin is larger than three million square kilometers, its watershed drains the water of thirty one U. S States. A lot of the fertilizers used in the fields are washed away into the Gulf of Mexico. This humongous amount of water and nutrients are a limitless supply to grow Sargasso.
2 There are heavy traffic marine routes that connect Tampa and New Orleans, as clearly indicated when we search in the internet for Gulf of Mexico Marine Routes (http://www.shiptraffic.net/2001/04/gulf-of-mexico-ship-traffic.html). However at the Northeast of that line there is no registered activity in the map. So, Northeast of the line between Clearwater and Pensacola there is an area of more than 30,000 square kilometers without marine route activity ideal to grow Sargasso.
3 Human Activity in this area. National Parks and some small towns are scattered in the area. There is fishing activity and instead of reducing the fishing business, the Sargasso nursery will increase it, being the place for fish to spawn and feed. Their fish harvest will incredibly increase too. At the same time, fishing will benefit the seaweed growth, reducing in some amount the fishes that forage from the seaweed.
4 Low waves. This area is flat so waves are very shallow. The mesh walls can be short, reducing considerably the installations costs.
5 Currents. There are circular currents going in opposite directions. At the north of this area some currents goes towards New Orleans. And at the south of this area there are mild currents in South direction. A few kilometers South the current flow into a strong current that goes South and after passing the Keys surround the Florida peninsula and pass the Maine State. So this area has the ideal place to nurse Sargasso and also has the currents that can bring the Sargasso load to the desired area. So this is not a minor event, the West side of Florida has the potential to naturally grow huge amounts of Sargasso and also deliver them any place in the Atlantic Coast from New Orleans up to Maine State.
6 No harm for coral reefs: There is not any coral reef activity in this area.

The embodiment to use in this scenario would be the Sixth Embodiment with all the specifications, a very large structure but instead of being square it will have an irregular shape. This model has a straight mesh that goes from Pensacola to Clearwater and it adapts to the shores of Florida and always staying three hundred meters away from the shore. This area covers a surface of thirty thousand square kilometers. It will have two funnel areas of discharge, NW and SE to ship Sargasso mass towards New Orleans and the Gulf Stream current.

The Seaweed duplicates its mass every twenty days. Taking into account the loss due to fish consumption, I will consider that the Sargasso duplicates its mass every thirty days. Starting with ten kilometer square of Sargasso in a year the mass will cover thirty thousand square kilometers of seaweed. One square meter of nursery will produce at least one cubic meter of mass of Sargasso every four month. One square kilometer of nursery will produce every four months a million cubic meters of Sargasso. Thirty thousand kilometer of nursery will produce thirty thousand millions cubic meters of Sargasso every four months (30,000,000,000 m3).

Once the nursery is full with Sargasso there are many different opportunities disclosed above regarding what to do with the load. Some of them are:
Raise the land level and as fertilizer.

The area of the Florida State is a hundred seventy thousand square kilometers (170,000). This means that every eighteen months there is enough seaweed to cover all Florida with a layer of seaweed one meter high.
Coast protection.

The Atlantic coast is thirty three hundred kilometers long and the Gulf coast is twenty six hundred kilometer long, adding up to six thousand kilometers long. So just to illustrate what it means that amount of Sargasso, every four months both coasts could be covered with a Sargasso wall one hundred meter wide and fifty meter tall. A very powerful vision.
Land reclamation.

Eighteen thousands years ago, the most recent Ice Age, Florida's width was double. The rise of the sea level only a few meters high made Florida shrank. The mentioned above Sargasso nursery has the potential to fill that space and create elevated soil protecting the existing Florida land.

This is the equivalent of a new piece of land two hundred kilometers long by five kilometers wide and 30 meters high. The mass will settle and shrink to a height of ten meters high. This new piece of land can be built as an extension of the mainland creating a new barrier protection. Or it can be used as a shore barrier embankment.

### CONCLUSION, RAMIFICATIONS, AND SCOPE

I have shown many embodiments. Sometimes different embodiment are used together complementary to each other and sometimes they are used on their own. Each embodiment has different parts and specifications. However those specified parts of one embodiment can be used or be associated with other embodiments and the specifications can be used in any other structures interchangeably. Except from the surrounding bag, all the other embodiments have mesh side walls that restrain the seaweed to a particular area. I show different ways to build the side walls. Some of those elements are fiberglass rods of different diameters, wooden poles, metallic floaters, floaters made out of fifty five gallon plastic drum, continuous tubular floaters, pool noodles, mooring objects, helical mooring screws, lineal anchor ribbon, lights and meshes. Each embodiment is distinctive in its structure shape and function. The mesh side walls of each embodiment can be built with any of the elements cited above, interchangeably.

I also associated a particular embodiment with a way to deliver the Sargasso and with a particular purpose, however any embodiment can be used with a different delivery method and the Sargasso produced can be used in any other purpose. Even though I developed these structures to solve some issues related to the East of US, the same structures and methods can be used anywhere in the world, where applicable.

Sargasso is a pelagic seaweed that grows extremely fast, so nowadays it is only a big problem. If Sargasso is cultivated through any other method different to this one, the shipping costs to take it out from the water, load it in a truck and deliver it to its destinations, would make the activity unprofitable. It is thanks to this method of “Farming Sargasso” that Sargasso has a huge potential of benefits. The “Farming Sargasso” method allows to regularly deliver huge amounts of Sargasso mass to a particular area almost without any shipping costs.

Everybody is aware of the wrong impact humans are doing to our planet. As population grows, there are so many needs and so few resources, that we are unable to change directions. However, these Sargasso structures are so beneficial to wildlife, to sea water, to shores, and therefore to the planet. And at the same time has so many possibilities to make a profit growing them.

I claim:

1. A method for cultivating Sargasso seaweed in tempered and warm sea waters rich in nutrients inside a non rigid nursery structure wherein said seaweed is not attached to any part of said nursery structure and has a mesh that restrain said seaweed to grow inside said structure, whereby huge amounts of Sargasso mass is produced regularly.

2. The method of claim 1 wherein the method also includes means to reduce shipping costs either using the Sargasso in situ or delivering it using the sea currents and waves.

3. The method of claim 2 wherein said nursery structure filled with Sargasso is used in situ, and can be used for one of the following purposes, as a fish nursery, as a sewage treatment plant, as a plant to reduce pollutants from fish nurseries or other industries.

4. The method of claim 2 wherein said huge amounts of Sargasso mass, using mainly the energy and direction of the waves and currents, are carried to other places to be used.

5. The method of claim 4 wherein said Sargasso mass, as a fertile bulk mass, can be used in land reclamation, shore barrier protection, raise the soil level, artificial island creation, low land landfill.

6. The method of claim 4 wherein said Sargasso mass, in mainland can be used as animal food, fertilizer, mulch, chicken bedding, substrate for plants.

7. The method of claim 4 wherein the Sargasso can be liquefied in ponds filled with fresh water and pumped to mainland to be used as a liquid fertilizer.

8. The method of claim 4 wherein the nursery structure is placed close to the site where the Sargasso will be used and with the currents and waves delivered to said site.

9. The method of claim 4 wherein the nursery structure is located away from the site where the Sargasso will be needed and uses a mobile nursery structure to carry the seaweed utilizing as much as possible the currents and the waves to deliver the seaweed to the desired place.

10. A sea surface seaweed non rigid nursery structure attached to one or more mooring points in the seabed by one or more ropes to grow pelagic seaweed not attached to any part of said nursery structure, comprising of a restraining mesh that, despite the waves and currents in the sea, maintains the seaweed inside said structure, whereby huge amounts of Sargasso mass is produced regularly.

11. The nursery of claim 10 wherein said mesh has complete surrounding walls so regardless of the strengths of the waves the Sargasso stays inside said nursery whereby it can be used in rough seas to grow Sargasso or to be used as a shore barrier during storms.

12. The nursery of claim 10 wherein said mesh is open at the top and has a floor and lateral walls sustained by floaters, so Sargasso is unable to exit underneath the mesh whereby the nursery can be untied and used for transportation of Sargasso on calm sea waters.

13. The nursery of claim 10 wherein said mesh has floating lateral walls and anchor points, whereby Sargasso can grow in big extensions of calm seas with minimal expenses.

14. The nursery of claim 13 wherein said structure is longitudinal and placed parallel to the land that protects, and has one external lateral wall and one internal lateral wall wherein both lateral wall are made by pieces of mesh in a “V” shape leaving a space between said pieces, so the Sargasso adrift enters the structure crossing the external wall but it is retained inside the nursery by internal meshes that distribute the Sargasso to grow in all areas, and when the structure is full of Sargasso it exits the structure through the internal wall, whereby the nursery smooths the strength of the waves and liberates regularly Sargasso that accumulates between said nursery and said land, creating a thick layer of dead Sargasso that protects the land from the wave.

15. The nursery of claim 13 wherein said structure is longitudinal and placed parallel to the shore and has one external lateral wall made by pieces of mesh in a “V” shape leaving a space between said pieces, so the Sargasso adrift enters the structure crossing the external wall but is retained inside the nursery by internal meshes that distribute the Sargasso to grow in all areas, and when the structure is full of Sargasso it exit the structure and is forced to enter into pouch nets that are anchored to the seabed, whereby the Sargasso adrift does not reach the beaches and said Sargasso accumulates in the pouches creating solid sandbars.

16. A method of cultivating pelagic seaweed inside mesh structures in the sea and use the seaweed mass as a means to nourish the soil and rise the soil level whereby said seaweed mass can be used for one of the following purposes, the creation of artificial islands, the creation of sandbars, the creation of embankments, new land reclamations, solidifying and rising the dunes, covering low rocky land by the sea with fertile soil, the creation of barrier islands, the creation of fertile soils close to the sea.

17. The method of claim 16 wherein the Sargasso nursery structures are placed at the Florida Gulf of Mexico coast and said nursery are made of floating lateral wall mesh anchored to the seabed whereby Sargasso mass is produced regularly inside said structures and using the currents and waves is delivered to the designated place to be used.
